(19) United States
(12) Patent Application Publication
(10) Pub. No.: US 2002/0078205 A1
(43) Pub. Date: Jun. 20, 2002

(54) Resource control facility

(76) Inventor: Lloyd Nolan, Ennis (IE)

Correspondence Address: Hoffmann & Baron, LLP, 6900 Jericho Turnpike, Syosset, NY, 11791, US

(21) Appl. No.: 09/992,820

(22) Filed: Nov. 14, 2001

(30) Foreign Application Priority Data
Nov. 17, 2000 (IE) S2000/0933
Nov. 17, 2000 (IE) 2000/0934
Nov. 17, 2000 (GB) 0028084.2

(51) Int. Cl. G06F 15/173

(52) U.S. Cl. 709/225

(57) ABSTRACT

A resource version control facility to overcome the technical difficulties associated with efficient control of multi task and multi resource projects in a distributed environment. A central datastore is connected to a number of local servers and a number of resource control workstations used to update parametric data for given resources or tasks. The provision controlled access and amendment to the datastore ensures that the latest version of project management code is available to each amendment workstation within the environment to allow modification to be made by any of the authorised personnel working on the project. In addition, the invention ensures that access is maintained to previously stored versions of the data for validation purposes without placing excessive demands on the central datastore.

The present invention relates to a resource control facility for use in a computer system and more particularly to a resource version control facility to overcome the technical difficulties associated with efficient control of multi task projects in a distributed environment.

Management of complex projects having large numbers of resources requires continuous monitoring of evolving tasks to ensure that the latest version or status of the management plan is available to authorised project personnel. For the purposes of this specification, management plans for a given project are referred to in terms of resource data blocks containing parametric data relating to the project. The nature of this software code does not form part of the current invention but relates instead to the technical problems associated with the delivery of accurate and timely project data while guaranteeing the integrity of such data as well as content tracking.

It is essential that changes to the project status whether overall or to a single task be controlled and noted centrally, to eliminate the possibility of parallel and or conflicting modifications being made by two independent resources. Additionally, amendments made must be subject to system wide testing which may highlight errors arising from interactions, which are invisible locally. For example, while it may appear logical for a low end resource to effect what appears to be a minor modification to the plan to meet a given deadline, however, it may require the use of facilities previously allocated by a higher resource and have an unacceptable impact on the overall plan. Similarly, a high end resource may have the option of altering deadlines that will be likely to have knock on effects to subsidiary resources. Therefore, in addition to storing and ensuring the availability of the updated code relating to the project and its associated tasks, it is vital that previously verified versions are also correctly stored. This presents a particular problem in the amendment or evolution of sophisticated large scale projects, as frequent modifications are made from a wide variety of sources. This is particularly important during initial amendment of the plan when liberal amendments are applied.

Another problem arises in that the amendment of such systems frequently occurs in a distributed environment having a wide variety of both hardware and software platforms. This makes accurate tracking of modifications and amendments made in real time very difficult. Often highly skilled project management personnel, using a variety of amendment tools, are required to control and manage the impact of changes to the plan, which significantly increases amendment costs. In addition to the time required to audit the changes made, it adversely affects portability of resources between the various platforms, necessitating retraining on the project management tools used.

It is known to provide a tracking system resident on a host computer to control the amendment of a large scale software project, however systems of this type are useful only for amendment of systems using a single amendment language and shared library resources. Similarly, United Kingdom Patent No. GB 2264575 B describes a method for updating software in a telecommunications network, which provides an effective method of updating software however, the method described is not suitable for distributed systems where consistency across a computer network cannot be guaranteed.

It is also known to store modifications to a standard block of code for local use and one such facility is described in United Kingdom Patent No. GB 2121570 B. This method allows a user to customise standard blocks of code however, it does not address the problem of distributing the amendments made to all other system users in real time.

There is therefore a need for a resource version control facility, which will overcome at least some of the aforementioned problems.

Accordingly, there is provided a resource version control facility for use in a distributed computer system of the type having a central project parameter datastore for storing project parameter data, a local server communicating with the datastore having receiving means for receiving and validating a data access request from at least one project management workstation connected to the local server, wherein the receiving means comprises means for extracting a resource type and user identifier from the data access request by reading at least one position dependent data segment from the data access request, means for validating the data access request by comparing a composite dataword provided by the identified resource type and the user identifier against equivalent length datawords contained in a secure memory array of valid composite datawords and means for retrieving a resource data block and attached resource status register associated with the validated data access request, accessing the resource status register to isolate a data portion containing a version identifier associated with the resource data block, transmitting a copy of the resource data block to the amendment workstation, locking the resource data block by setting a write protection bit in the resource status register and generating a replacement resource data block in the central datastore.

Preferably the replacement resource data block has an attached resource status register containing a pre-set write bit and includes the user identifier associated with the validated data access request, the code type, the identified version identifier and a time stamp. This prevents the latest version being accessible when withdrawn for amendment thereby eliminating the risk of parallel or contradictory amendments being undertaken.

Ideally the time stamp has a time indicator and date indicator referring to the physical time and date when the resource data block was transmitted. Thus, when a person wishing to update resource or data information discovers that a given resource data block has been removed for amendment is made aware of when and by whom the block was taken.

Preferably the version control facility includes means for detecting the presence of a replacement resource data block in the central datastore associated with a validated data access request from a amendment workstation and transmitting the replacement resource data block to the amendment workstation. Thus, the operative can base a decision as to whether he should contact the other person handling the task or resource information to seek return of the code.

Preferably the receiving means comprises:

means for identifying the code type of the data access request as a code return request by comparing a position dependent data segment from the data access request against a plurality of data access request types stored in a secure code type memory array; and

means for retrieving the replacement resource data block from the central datastore and validating the code return request by comparing portion of the identified code type, the identified version identifier and the user identifier of the code return request against the version identifier and user identifier stored in the replacement resource data block.

This prevents incorrect resource data blocks from being inserted on the central datastore.

Ideally the version control facility includes means for comparing a return resource data block associated with the validated code return request to the write protected resource data block associated with the data access request and storing code differences and the identified version identifier in a code difference file in the central datastore, updating the identified version identifier of the return resource data block, storing the return resource data block in the central datastore, unlocking by releasing a write protection bit in the resource status register, deleting the write protected resource data block and deleting the replacement resource data block from the central datastore.

The storage requirements on the central datastore being significantly by storing the latest version of the resource data block only and a single associated file containing modifications also increases processing efficiency as it is not necessary to process numerous lengthy file to access a chosen area of the fixed disk.

Ideally the version control facility includes means for detecting a difference between the identified version identifier of the code return request and the version identifier stored in the replacement resource data block and transmitting the replacement resource data block to the amendment workstation. This prevents a previous version of the resource data block which may have been stored locally by the person updating project data accidentally overwriting a version stored on the central datastore, thereby providing additional system security.

In one arrangement the version control facility includes means for identifying the code type of the data access request as a code regression request by comparing a position dependent data segment from the data access request against a plurality of data access request types stored in a secure code type memory array;

means for retrieving a resource data block associated with the code regression request and the code difference file, and

means for sequentially reading each portion of the code difference file, locating an associated portion in the retrieved resource data block for each read portion and substituting the read portion of the code difference file for the associated portion of the retrieved resource data block, decrementing the version identifier associated with the retrieved resource data block and storing the resource data block.

Thus, the procedure to produce a previous software version is provided in a simple manner without adversely affecting system performance.

Ideally the version control facility includes means for sequentially processing a plurality of a code regression request from an amendment workstation. This allows any previous version of the code to be regenerated using the difference files by a single developer request.

Preferably the version control facility includes

means for identifying the code type of the data access request as a code create request by comparing a position dependent data segment from the data access request against a plurality of data access request types stored in a secure code type memory array; and

means for creating a version identifier for a resource data block associated with the code create request and storing the resource data block, resource status register containing an associated version identifier on the central datastore.

In this way a system wide convention is enforced on all developers as each file must be created in a set manner. This eliminates the risk that different developers may introduce personal naming conventions or naming styles dictated by the operating system on which they work thereby making access by other developers difficult or impossible.

According to one aspect of the invention there is provided a version control facility for use in a distributed computer system of the type having a central datastore for storing software code, a local server communicating with the central datastore having receiving means for receiving and validating a data access request from at least one amendment workstation connected to the local server, wherein the receiving means comprises:

means for extracting a code type and user identifier from the data access request by reading at least one position dependent data segment from the data access request;

means for validating the data access request by comparing a composite dataword provided by the identified code type and the user identifier against the equivalent length datawords contained in a secure memory array of valid composite datawords; and

means for detecting the presence of a replacement resource data block in the central datastore associated with a validated data access request from an amendment workstation and transmitting the replacement resource data block to the amendment workstation.

According to another aspect of the invention there is provided a version control facility for use in a distributed computer system of the type having a central datastore for storing software code, a local server communicating with the central datastore having receiving means for receiving and validating a data access request from at least one amendment workstation connected to the local server, wherein the receiving means comprises:

means for extracting a code type and user identifier from the data access request by reading at least one position dependent data segment from the data access request;

means for validating the data access request by comparing a composite dataword provided by the identified code type and the user identifier against equivalent length datawords contained in a secure memory array of valid composite datawords;

means for identifying the code type of the data access request as a code return request by comparing a position dependent data segment from the data access request against a plurality of data access request types stored in a secure code type memory array; and

means for retrieving the replacement resource data block from the central datastore and validating the code return request by comparing portion of the identified code type, the identified version identifier and the user identifier of the code return request against the version identifier and user identifier stored in the replacement resource data block.

According to a further aspect of the invention there is provided a version control facility for use in a distributed computer system of the type having a central datastore for storing software code, a local server communicating with the central datastore having receiving means for receiving and validating a data access request from at least one amendment workstation connected to the local server, wherein the receiving means comprises:

means for extracting a code type and user identifier from the data access request by reading at least one position dependent data segment from the data access request;

means for validating the data access request by comparing a composite dataword provided by the identified code type and the user identifier against equivalent length datawords contained in a secure memory array of valid composite datawords;

means for identifying the code type of the data access request as a code regression request by comparing a position dependent data segment from the data access request against a plurality of data access request types stored in a secure code type memory array;

means for retrieving a resource data block associated with the code regression request and the code difference file, and

means for sequentially reading each portion of the code difference file, locating an associated portion in the retrieved resource data block for each read portion and substituting the read portion of the code difference file for the associated portion of the retrieved resource data block, decrementing the version identifier associated with the retrieved resource data block and storing the resource data block.

The invention will be more clearly understood from the following description of one embodiment thereof given by way of example only.

A distributed amendment environment incorporating a resource version control facility in accordance with the invention has a central datastore connected to a number of local servers by host connections. The local servers each have an associated operating system for controlling operation of a local network and communication with the central datastore. The operating system associated with each of the local servers is not necessarily compatible with the operating system of other local servers. Each of the local networks is used for communicating information between the local server and a number of resource control workstations. The resource control workstations may be of any suitable type either with or without local processing and storage capabilities and are used to update parametric data for given resources or relating to a single or multiple tasks.

The distributed amendment environment incorporating the version control facility is for controlling amendment of data relating to a large scale project in a distributed computing environment. The invention ensures that the latest version of project management code is available to each amendment workstation within the environment to allow modification to be made by any of the authorised personnel working on the project. The invention also provides that when data is being modified at one of the amendment workstations, that the code is not made available to another amendment workstation to prevent the occurrence of either parallel amendment or contradictory amendment. In addition, the invention ensures that access is maintained to previously stored versions of the data for validation purposes without placing excessive demands on the central datastore.

A project data access request is generated at a resource control workstation and transmitted to the central datastore. When an operative working at one of the workstations requires access to the central datastore to create or amend a block of project code a data access request is generated from the workstation. The request is passed along the local network and through the local server on to the host connection. The local servers, where appropriate, will convert the format of the request from the amendment workstation into a format suitable for accessing the central datastore.

The data access request is received and a data segment associated with a code type of the data access request is compared against a number of predefined data access request types. The data access request types are stored in a secure, code type memory array of the central datastore. Data access request types may relate to code retrieve requests, code return requests, code replace requests or code regression requests. When the data access request is recognised as a code retrieve request it is routed by the version control facility to a code retrieve requester. The received code retrieve request is split by the code requester into frames and the code type is taken from the first data frame. A user identifier is then extracted from the next frame of the code retrieve request received at the central datastore and the code type extracted and the user identifier extracted are appended to produce a composite dataword.

The composite dataword is compared with a number of equivalent length datawords stored in a secure portion of the central datastore until a match is found. When a match is found, the resource data block and attached resource status register associated with the code retrieve request are retrieved. The resource status register is read to isolate a data portion containing a version identifier associated with the resource data block. A copy of the original resource data block is produced and the copy is transmitted across the server connection and the local network to the amendment workstation where the code retrieve request originated.

A write protection bit, being the most significant bit of the resource status register is set to form a write protected replacement resource data block thereby preventing deletion or overwriting of the resource data block. A replacement resource data block is created containing brief text message to indicate that the resource data block has been removed for amendment purposes and indicating the user identifier and code type of the code retrieve request. Additionally, the replacement resource data block has a time stamp indicating the time and day on which the resource code was removed for further processing.

When the code retrieve request identified relates to a code retrieve request for which the resource data block associated with the code retrieve request has been removed, the presence of the write protected replacement resource data block is detected. The replacement resource data block is then copied and is transmitted across the host connection and the local network to the amendment workstation where the code retrieve request originated.

When the data access request is identified as a code return request, indicating that it is desired to return a resource data block removed using the operation described above. The code return request is routed by the version control facility at to a code return requester. The replacement resource data block associated with the code return request is retrieved from the central datastore. Comparing the code type of the data access request with the code type stored in the replacement resource data block validates the code type associated with the code return request. The version identifier of the data access request is compared against the version identifier of the replacement resource data block and the user identifier is compared against the user identifier stored in a replacement resource data block. In this way, the integrity of the system is assured by preventing unauthorised overwriting of resource data blocks and guaranteeing that no version identifier is skipped in the amendment cycle.

The return resource data block and the replacement resource data block are compared line by line and the differences noted are stored in a difference file. The difference file notes any amendments made to the code withdrawn from the central datastore previously, but does not store complete versions of the code. Such amendments may relate to a change in circumstances on a given task or to the availability of a given resource. The status at any given point of the combined code will indicate overall project status. Accordingly, the storage requirements on the central datastore are significantly reduced and the difference file may be archived or packed when required. Alternatively, the file may be left available for regression requirements.

The version identifier of the return resource data block is updated by incrementing a version number and the return resource data block with updated version identifier is stored in the central datastore. The write protection bit in the resource status register is unlocked and the write protected resource data block is deleted. The replacement resource data block is then similarly deleted from the central datastore.

When it is noted that the identified version identifier of the return request and the version identifier stored in the replacement resource data block are different, the replacement resource data block is re-transmitted to the workstation thereby preventing storage of amended code files out of sequence, this significantly improves the overall reliability of the distributed system in that it is not possible for files to be stored out of sequence.

When it is required to return to a previous version of the software, the data access request is recognised as a code regression request and the routed by the resource version control facility to a code regression requester. This may be necessary in the event that an authorised amendment made to the project plan has an unforeseen consequence discovered only on review. In this situation, it is often desireable to regress the plan to a status prior to the application of a given amendment. The resource data block associated with the code regression request is retrieved from the central datastore. The corresponding code difference file found is retrieved. Each portion of the code difference file is read into memory and the corresponding area of the retrieved resource data block is replaced by the memory contents as read from the code difference file. Each of the portions of the code difference file are read in turn from top to bottom until the entire contents have been substituted for the original contents of the retrieved resource data block. As the resource data block has been regressed or stepped back by one version, the version identifier contained in the resource status register associated with the resource data block is accordingly backdated and the resource data block is replaced by the regressed resource data block in the central datastore. This operation may be repeated a number of times to regress the software back to any desired version level.

When it is required to create a new block of code for an additional task or resource, to be stored on the central datastore the data access request is sent, containing details of the application for which the code create is sought, details relating to the users such as user identifier and source ID, task or resource name and code type, providing the user has the necessary authorisations to create a file of this type, then the code is stored in the central datastore and version identifier assigned.

It will be appreciated that the resource version control facility outlined above provides a significant improvement in the tracking and auditing necessary to manage sophisticated projects in a distributed parameter amendment environment. Additionally, this is achieved while minimising the memory requirements on the central datastore to which the distributed environment is connected and without requiring the use of operating system specific software. As the project developers may use existing systems to transmit and receive code from the central datastore, no re-training is required in the event of a move or software changes.

It will noted that access requests may be easily limited and that configuration relating to the use of applications by certain developers may be easily updated by an authorised person changing the contents of the secure memory array stored in the central datastore.

The invention is not limited to the embodiment hereinbefore described but may be varied in both construction and detail within the scope of the amended claims.

1. A resource version control facility for use in a distributed computer system of the type having a central project parameter datastore for storing project parameter data, a local server communicating with the datastore having receiving means for receiving and validating a data access request from at least one project management workstation connected to the local server, wherein the receiving means comprises means for extracting a resource type and user identifier from the data access request by reading at least one position dependent data segment from the data access request, means for validating the data access request by comparing a composite dataword provided by the identified resource type and the user identifier against equivalent length datawords contained in a secure memory array of valid composite datawords and means for retrieving a resource data block and attached resource status register associated with the validated data access request, accessing the resource status register to isolate a data portion containing a version identifier associated with the resource data block, transmitting a copy of the resource data block to the amendment workstation, locking the resource data block by setting a write protection bit in the resource status register and generating a replacement resource data block in the central datastore.

2. A resource version control facility as claimed in claim 1 including means for detecting the presence of a replacement resource data block in the central datastore associated with a validated data access request from a amendment workstation and transmitting the replacement resource data block to the amendment workstation.

3. A resource version control facility as claimed in claim 1 wherein the receiving means comprises:
means for identifying the code type of the data access request as a code return request by comparing a position dependent data segment from the data access request against a plurality of data access request types stored in a secure code type memory array; and
means for retrieving the replacement resource data block from the central datastore and validating the code return request by comparing portion of the identified code type, the identified version identifier and the user identifier of the code return request against the version identifier and user identifier stored in the replacement resource data block.

4. A resource version control facility as claimed in claim 1 incorporating:
means for identifying the code type of the data access request as a code regression request by comparing a position dependent data segment from the data access request against a plurality of data access request types stored in a secure code type memory array;
means for retrieving a resource data block associated with the code regression request and the code difference file, and
means for sequentially reading each portion of the code difference file, locating an associated portion in the retrieved resource data block for each read portion and substituting the read portion of the code difference file for the associated portion of the retrieved resource data block, decrementing the version identifier associated with the retrieved resource data block and storing the resource data block.

5. A resource version control facility as claimed in claim 1 incorporating:
means for identifying the code type of the data access request as a code create request by comparing a position dependent data segment from the data access request against a plurality of data access request types stored in a secure code type memory array; and
means for creating a version identifier for a resource data block associated with the code create request and storing the resource data block, resource status register containing an associated version identifier on the central datastore.

6. A resource version control facility for use in a distributed computer system of the type having a central datastore for storing software code, a local server communicating with the central datastore having receiving means for receiving and validating a data access request from at least one amendment workstation connected to the local server, wherein the receiving means comprises:
means for extracting a code type and user identifier from the data access request by reading at least one position dependent data segment from the data access request;
means for validating the data access request by comparing a composite dataword provided by the identified code type and the user identifier against the equivalent length datawords contained in a secure memory array of valid composite datawords; and
means for detecting the presence of a replacement resource data block in the central datastore associated with a validated data access request from an amendment workstation and transmitting the replacement resource data block to the amendment workstation.

7. A version control facility for use in a distributed computer system of the type having a central datastore for storing software code, a local server communicating with the central datastore having receiving means for receiving and validating a data access request from at least one amendment workstation connected to the local server, wherein the receiving means comprises:
means for extracting a code type and user identifier from the data access request by reading at least one position dependent data segment from the data access request;
means for validating the data access request by comparing a composite dataword provided by the identified code type and the user identifier against equivalent length datawords contained in a secure memory array of valid composite datawords;
means for identifying the code type of the data access request as a code return request by comparing a position dependent data segment from the data access request against a plurality of data access request types stored in a secure code type memory array; and
means for retrieving the replacement resource data block from the central datastore and validating the code return request by comparing portion of the identified code type, the identified version identifier and the user identifier of the code return request against the version identifier and user identifier stored in the replacement resource data block.

8. A resource version control facility for use in a distributed computer system of the type having a central datastore for storing software code, a local server communicating with the central datastore having receiving means for receiving and validating a data access request from at least one amendment workstation connected to the local server, wherein the receiving means comprises:
means for extracting a code type and user identifier from the data access request by reading at least one position dependent data segment from the data access request;
means for validating the data access request by comparing a composite dataword provided by the identified code type and the user identifier against equivalent length datawords contained in a secure memory array of valid composite datawords;
means for identifying the code type of the data access request as a code regression request by comparing a position dependent data segment from the data access request against a plurality of data access request types stored in a secure code type memory array;
means for retrieving a resource data block associated with the code regression request and the code difference file, and
means for sequentially reading each portion of the code difference file, locating an associated portion in the retrieved resource data block for each read portion and substituting the read portion of the code difference file for the associated portion of the retrieved resource data block, decrementing the version identifier associated with the retrieved resource data block and storing the resource data block.
